(19) United States
(12) Patent Application Publication
(10) Pub. No.: US 2015/0367502 A1
(43) Pub. Date: Dec. 24, 2015

(54) Collapsible Toolbag for Use With Hand Truck

(71) Applicants: Mathew Ryan Hassler, San Antonio, TX (US); David Arredondo, San Antonio, TX (US); Terrence Kennedy, San Antonio, TX (US); Daniel F. Cabana, Cibolo, TX (US)

(72) Inventors: Mathew Ryan Hassler, San Antonio, TX (US); David Arredondo, San Antonio, TX (US); Terrence Kennedy, San Antonio, TX (US); Daniel F. Cabana, Cibolo, TX (US)

(73) Assignee: ROOSTER PRODUCTS INTERNATIONAL, INC., San Antonio, TX (US)

(21) Appl. No.: 14/307,722

(22) Filed: Jun. 18, 2014

(51) Int. Cl. B25H 3/00; B65D 33/24; B65D 33/06; B65D 33/02

(52) U.S. Cl. CPC B25H 3/00; B65D 33/02; B65D 33/24; B65D 33/06

(57) ABSTRACT

A toolbag with an enclosure having a bottom, a pair of sidewalls adjacent to the bottom, a front wall adjacent to the sidewalls and the bottom, and a rear wall adjacent to the sidewalls and the bottom. The enclosure defines an at least partially-enclosed volume. The sidewalls are joined to the rear wall at a first corner and a second corner. A first flap and a second flap are rotatably attached to the rear wall and may be fastened together to secure the toolbag to a hand truck or other conveyance. The second flap is attached to the rear wall opposite the first flap. At least one pair of straps is connected to the outer surface of the rear wall. The enclosure of the toolbag being collapsible and having a foldable liner to provide stability when the toolbag is in an expanded state.

### CROSS REFERENCES TO RELATED APPLICATIONS

Not applicable.

FEDERALLY-SPONSORED RESEARCH

Not applicable.

### BACKGROUND OF THE INVENTION

1. Field of the Invention.

The present invention relates to the field of bags. More specifically, the present invention relates to a toolbag that is useful for storing tools and that may be removably attached to a hand truck for transport.

2. Description of the Related Art.

Tool carriers are known to be useful for workers needing to carry a group of tools to and from a work site for a specific job. Although tool carriers have historically been made of metal, more recently, fabric covered tool carriers have become popular. Exemplary prior art tool carriers include those disclosed in U.S. Pat. Nos. 6,823,992; 6,991,104; 7,314,133, 7,314,134; and 8,651,273. While these tool carriers and others are useful in some instances, there are still numerous deficiencies and the potential for more useful tool carriers and tool carrier features. In particular, these devices provide inadequate means for attachment of the carriers to a hand truck.

### SUMMARY OF THE INVENTION

The invention is a toolbag with an enclosure having a bottom, two sidewalls adjacent to the bottom, a front wall adjacent to the sidewalls and the bottom, and a rear wall adjacent to the sidewalls and the bottom. The enclosure defines an at least partially-enclosed volume. The sidewalls are joined to the rear wall at a first corner and a second corner. A first flap and a second flap are rotatably attached to the rear wall. The second flap is attached to the rear wall opposite the first flap. At least one pair of straps is connected to the outer surface of the rear wall. The toolbag rests on a hand truck and the first and second flaps and the first and second straps are used to secure the toolbag to the backrest of the hand truck. The toolbag is also collapsible for ease of storage and transport.

### BRIEF DESCRIPTION OF THE DRAWINGS

FIG. 1 is front perspective view of an embodiment of the invention.

FIG. 2 is a rear perspective view of the embodiment partially attached to a hand truck.

FIG. 3 is a rear perspective view of the embodiment partially attached to the hand truck.

FIG. 4 is a rear perspective view of the embodiment attached to the hand truck.

FIG. 5 is a front perspective view of the embodiment in a partially compressed state.

FIG. 6 is a side view of the embodiment in a compressed state.

### DETAILED DESCRIPTION OF CERTAIN EMBODIMENTS

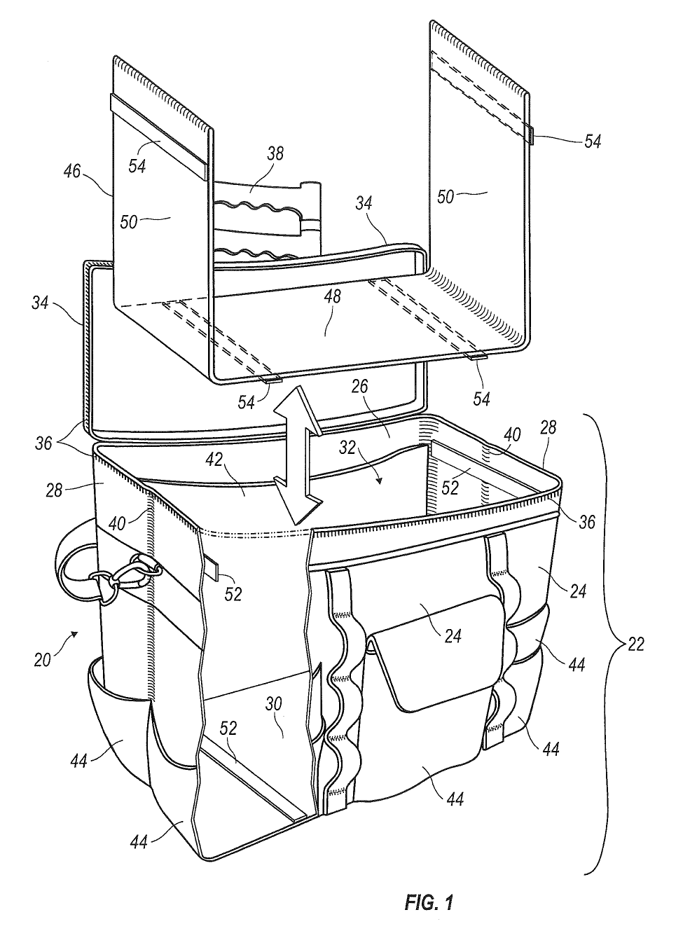

FIG. 1 shows an embodiment of a toolbag 20 having the features of the present invention. The toolbag 20 has a cuboid enclosure 22 with a front wall 24, a rear wall 26, and opposing sidewalls 28 adjacent to the front wall 24 and rear wall 26. A flexible bottom 30 is connected to the front wall 24, rear wall 26, and sidewalls 28.

Together, the front wall 24, rear wall 26, sidewalls 28, and bottom 30 define a partially-enclosed volume 32. A flexible top piece 34 is connected to the rear wall 26 and may be fastened to the front wall 24 and sidewalls 28 using a zipper 36 to completely enclose the volume 32. In the preferred embodiment, the flexible top piece 34 is attached to the rear wall 26 with a flexible fabric hinge (not shown) which is stitched to both the rear wall 26 and the flexible top piece 34. However, it is anticipated that other methods of attaching the flexible top piece 34 may be used.

The sidewalls 28 have folds 40 extending from the top edge to the bottom edge of the sidewalls 28 at a mid-width position. An interior pocket 42 is formed in the volume 32 against the rear wall 26. Exterior pockets 44 of various sizes and shapes are positioned on the exterior of the front wall 24 and sidewalls 28 for carrying tools and parts.

To provide stability to the toolbag 20, the toolbag 20 includes a liner 46 having a bottom 48 joined at its wide side edges to two sides 50. Each side 50 is rotatable relative to the bottom 48 so that the liner 46 may be folded into a generally flat configuration or configured into square-U shape corresponding to the sidewalls 28 and bottom 30 of the enclosure 22. When generally flat, the liner 46 may occupy the space of the interior pocket 42 and be held against the rear wall 26. The liner 46 is more rigid than the enclosure bottom 30. In order to secure the liner 46 to the bottom 30 and sidewalls 28 of the enclosure 22, interior surfaces of the bottom 30 and sidewalls 28 are lined with “hook” or “loop” strips 52. One side of the liner 46 is lined with corresponding “hook” or “loop” strips 54 that correspond to the positions of the “hook” or “loop” strips 52 within the enclosure 22.

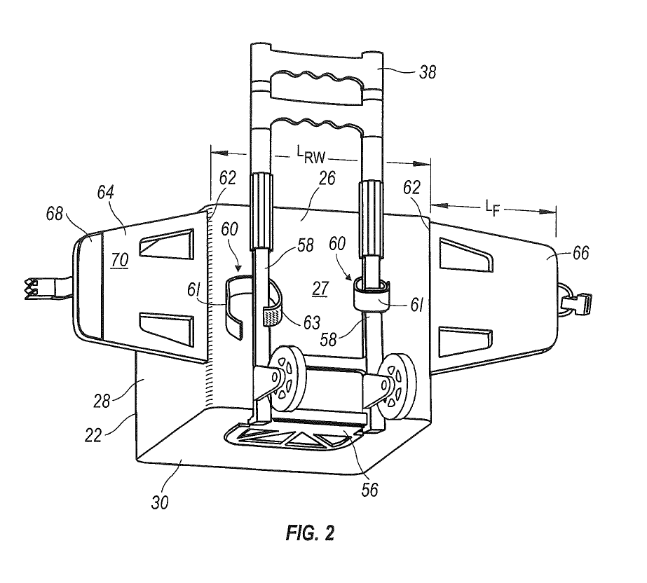

Referring to FIG. 2, the enclosure bottom 30 may be positioned on a hand truck 38 that has a ledge 56 and a back rest 58. Two pairs of hook-and-loop straps 60 are attached to the outer surface 27 of the rear wall 26, with each pair consisting of one “hook” strap 61 and one “loop” strap 63. Each strap of a pair 60 may be fastened to the other strap of the pair to form a closed loop around part of the hand truck 38, such as the back rest 58. While FIG. 2 discloses use of the hook-and-loop straps, alternative embodiments may use other types of fastening connects such as snap-fit buckles, clasp, slide, or conventional buckle.

Corners 62 are formed by the junction of the rear wall 26 to the sidewalls 28. First and second flaps 64, 66 are connected to the enclosure 22 at the corners 62 and are rotatable around the corners 62. Each flap 64, 66 has a length L_{F} greater than one-half of the length L_{RW} of the rear wall 26 so that when both flaps 64, 66 are rotated to positions adjacent the rear wall 26, the flaps 64, 66 at least partially overlap.

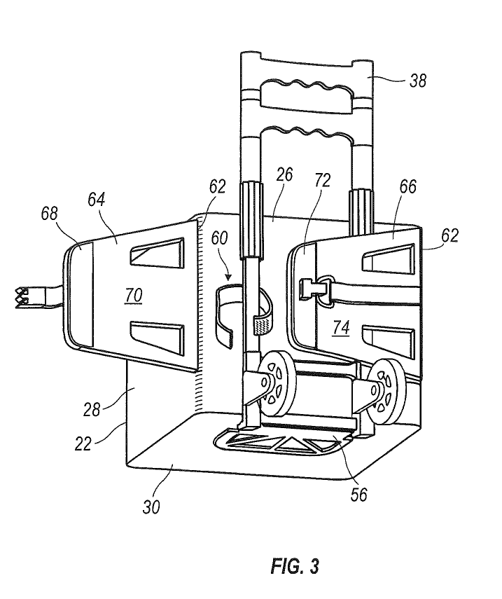

Referring to FIG. 3, a piece of “hook” or “loop” material 68 is attached to a surface 70 of the first flap 64 and a piece of corresponding “hook” or “loop” material 72 is attached to a surface 74 of the second flap 66. When the flaps are rotated to a position adjacent the rear wall, the “hook” or “loop” material 72 of the second flap 66 may contact the “hook” or “loop” material 68 of the first flap 64.

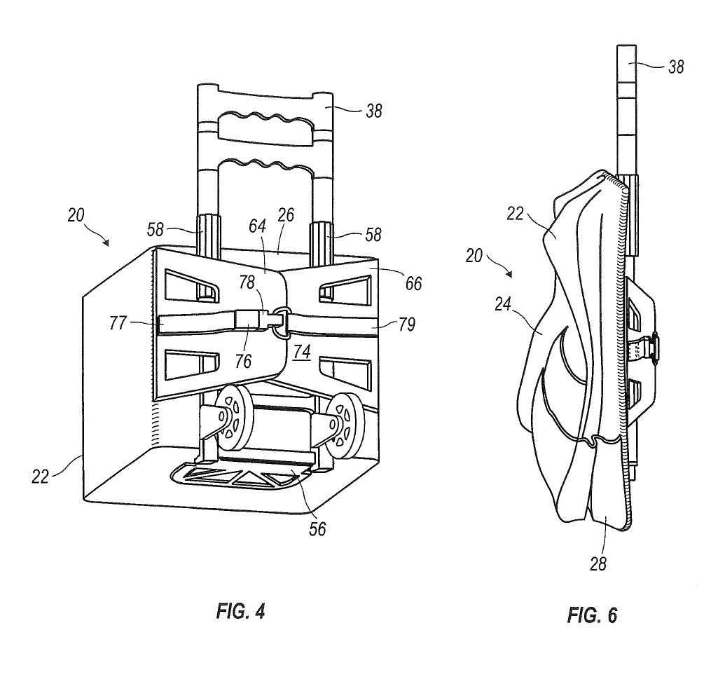

FIG. 4 shows the toolbag 20 secured to the hand truck 38. The strap pairs 60 (obscured) are connected to the backrest 58 as shown in FIG. 3 and the first flap 64 is attached to second flap 66 as described with reference to FIG. 3. In addition, a hook 76 is connected to the first flap 64 with a strap 77 and a corresponding catch 78 is attached to the second flap 66 with a strap 79. The hook 76 is connected to the catch 78 to form a closed snap-fit buckle that further secures the attachment of the enclosure 22 to the hand truck 38.

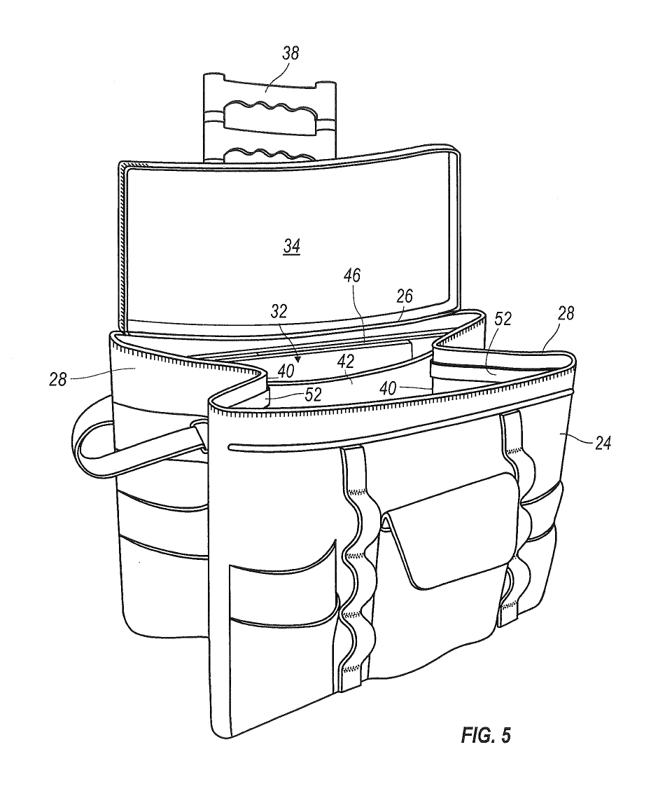

The enclosure 22 may be configured between an expanded state as showin in FIGS. 1-4 and a collapsed state as shown in FIGS. 5-6 for easier transport and storage,. Referring to FIG. 5, to configure the enclosure 22 in a collapsed state, the liner 46 is folded flat and placed in the space of the inner pocket 42. The front wall 24 is then moved toward the rear wall 26, which causes the sidewalls 28 to fold inward at the folds 40 toward the center of the volume 32. The flaps 64, 66 are connected to each other as described with reference to FIG. 4. FIG. 6 shows the enclosure 22 in a collapsed state.

Referring back to FIG. 5, to configure the enclosure 22 in an expanded state from the collapsed state, the front wall 24 is pulled away from the rear wall 26, which causes the sidewalls 28 to unfold to a generally planar shape. The liner 46 may be removed from the space of the inner pocket 42, unfolded into a U-shape as shown in FIG. 1, and then positioned within the enclosure volume 32 so that the bottom 48 of the liner 46 is in contact with the enclosure bottom 30 and each liner side 50 is in contact with the sidewalls 28. The liner 46 is inhibited from movement by the hook-and-loop attachment with the enclosure 22. The rigidity of the liner 46 inhibits the sidewalls 28 from folding in and provides stability for the enclosure bottom 30.

The present invention is described in terms of a specifically-described embodiment. Those skilled in the art will recognize that alternative embodiments of such device can be used in carrying out the present invention. Other aspects and advantages of the present invention may be obtained from a study of this disclosure and the drawings, along with the appended claims.

I claim:

1. A toolbag comprising:
an enclosure having a bottom, two opposing sidewalls adjacent to the bottom, a front wall adjacent to the two sidewalls and the bottom, and a rear wall adjacent to the two sidewalls and the bottom, the enclosure defining an at least partially-enclosed volume, wherein the sidewalls are joined to the rear wall at a first corner and a second corner;
a first flap rotatably attached to the outer surface of the rear wall; and
a second flap rotatably attached to the outer surface of the rear wall on the other side, the second flap being fastenable with the first flap.

2. The toolbag of claim 1 wherein the first flap is fastened to the second flap.

3. The toolbag of claim 1 comprising at least one pair of hook and loop straps attached to the outer surface of the rear wall.

4. The toolbag of claim 1 wherein the first flap is attached to the first corner, and the second the second flap attached to the second corner.

5. The toolbag of claim 1 wherein each of the sidewalls comprises a vertical fold extending from a top edge to a bottom edge of each sidewall.

6. The toolbag of claim 1 comprising:
a liner having a liner bottom and opposing liner sides rotatably connected to said bottom.

7. The toolbag of claim 6 wherein the liner bottom is fastened to the bottom of the enclosure and the liner sides are fastened to the sidewalls of the enclosure.

8. The toolbag of claim 6 comprising:
a pocket adjacent an interior wall of said enclosure.

9. The toolbag of claim 8 wherein said opposing sides of said liner are rotated to a position resting generally flat against said bottom of said liner and said liner is stored in said pocket.
